(19) United States
(12) Patent Application Publication
(10) Pub. No.: US 2018/0150018 A1
(43) Pub. Date: May 31, 2018

(54) CLEANING BLADE

(71) Applicant: SUMITOMO RIKO COMPANY LIMITED, Komaki-shi (JP)

(72) Inventors: Yasunori Nimura, Komaki-shi (JP); Satoshi Suzuki, Komaki-shi (JP); Kazushi Yamaguchi, Komaki-shi (JP)

(73) Assignee: SUMITOMO RIKO COMPANY LIMITED, Komaki-shi (JP)

(21) Appl. No.: 15/865,497

(22) Filed: Jan. 9, 2018

Related U.S. Application Data
(63) Continuation of application No. PCT/JP2016/074674, filed on Aug. 24, 2016.

(30) Foreign Application Priority Data
Sep. 30, 2015 (JP) 2015-192404

(51) Int. Cl. G03G 21/00

(52) U.S. Cl. CPC G03G 21/0017

(57) ABSTRACT

Provided is a cleaning blade to be used for removing a residual toner that remains on a surface of a counterpart member in an electrophotographic image forming device, by sliding contact with the counterpart member. The cleaning blade includes a conductive support including a plate-shaped portion; a blade part that is formed on the plate-shaped portion and is made of a polyurethane rubber; and a conductive adhesion layer that is provided between the plate-shaped portion and the blade part and contains a conductive agent. In the cleaning blade, the blade part contains a potassium salt in an amount of 0.3 mass % or more and less than 10 mass %, and the potassium salt includes at least one kind of anion selected from the group consisting of CF₃SO₂C₄F₉SO₂N⁻, (CF₃SO₂)₂N⁻, (FSO₂)_{N}⁻, C₂₈H₂₈BO₆⁻, AlCl₄⁻, Al₂Cl₇⁻, NO₃⁻, BF₄⁻, PF₆⁻, CF₃COO⁻, CF₃SO₃⁻, (CF₃SO₂)₃C⁻, AsF₆⁻, SbF₆^{×}, F(HF)N⁻, CF₃CF₂CF₂CF₂SO₃⁻, (CF₃CF₂SO₂)₂N⁻, CF₃CF₂CF₂COO⁻, (C₄F₉SO₂)₂N⁻, CF₂(CF₂SO₂)₂N⁻ and CF₃SO₂NH₂⁻.

### CROSS-REFERENCE

This application is a Continuation of International Application No. PCT/JP2016/074674 filed on Aug. 24, 2016, which claims priority to Japanese Patent Application No. 2015-192404 filed on Sep. 30, 2015. The entire contents of which are incorporated herein by reference.

### TECHNICAL FIELD

The present disclosure relates to a cleaning blade, and more particularly to a cleaning blade for use in an electrophotographic image forming device.

### BACKGROUND ART

In an electrophotographic image forming device, a cleaning blade is employed to clean, for instance, the surface of an image bearing member such as a photoreceptor or an intermediate transfer belt. The cleaning blade has a blade part, of which the front edge portion is pressed onto the surface of the image bearing member or the intermediate transfer belt as a counterpart member. A residual toner that remains on the surface of the counterpart member is scraped off and removed by sliding contact between the counterpart member and the edge portion.

As one example of conventional cleaning blades, a cleaning blade composed of a metallic support that has a plate-shaped portion and a blade part that is formed of a plate-shaped polyuretharic rubber and is bonded to the plate-shaped portion on the front end side thereof through an adhesion layer is widely known.

Patent document 1 as a prior art, describes a conductive composition that contains a polyol, a urethane polymer, and a boric acid ester compound as a material for forming a conductive elastic layer in a cleaning blade.

### PRIOR ART DOCUMENT

### Patent Document

Patent Document 1: Japanese Patent Number 3772402

### SUMMARY OF THE INVENTION

In consideration of a demand for higher image quality in an image forming device in recent years, a toner having a spherical shape with a small diameter has been used. Accordingly, a slight clearance produced between the surface of the counterpart member and the edge portion of the blade portion allows the toner to easily slip therethrough. Thus, it has become difficult to efficiently scrape off the residual toner into a toner recovery box utilizing rubber elasticity of the blade part.

In the image forming device, the residual toner is ordinarily in a charged state. Thus, an electrostatically repulsive force is generated between particles of the toner collected in the toner recovery box. Consequently, in some cases, the toner cannot be stored in the toner recovery box and may flow over from the toner recovery box.

As one measure to address the aforementioned problem, it is conceivable to scrape off the residual toner while destaticizing the residual toner with the cleaning blade. For this purpose, it is necessary for the blade part, to have electroconductivity. To impart electroconductivity to the blade part, it is conceivable to add a carbon black or an ion conductive agent to the blade part.

However, because the dispersion state of a carbon black is difficult to control, it is difficult to stabilize the volume electric resistance in the blade par t. Further, the carbon black added to the blade part makes the compression set arid permanent elongation of the blade part worse, and increases the hardness of the blade part. Thus, the rubber elasticity of the polyurethane rubber is impaired, which causes troubles in scraping off of the toner.

On the other hand, if an ion liquid is added to the blade part, bleeding tends to be caused. There arises a problem in that the bleeding of the ion liquid would contaminate the counterpart member. Besides,, common ion conductive agents such as lithium bis(trifluoromethanesulfonyl) imide (LiTFSI) and lithium bis(fluorosulfonyl) imide (LiFSI) deteriorate the reactivity of a urethane catalyst in forming the blade part. For this reason, under producing conditions as conventionally applied, the curability of the blade part is lowered to thereby deteriorate the adhesiveness of the blade part to the plate-shaped portion. Therefore, it is not possible to produce a cleaning blade that is able to scrape off the residual toner while destaticizing the residual toner.

The present disclosure has been made in consideration of such a background as described above, and it is intended to provide a cleaning blade that hardly contaminates a counterpart member, hardly impairs the reactivity of a urethane catalyst, and is able to scrape off a residual toner while destaticizing the residual toner.

One aspect of the present disclosure provides a cleaning blade to be used for removing a residual toner that remains on a surface of a counterpart member in an electrophotographic image forming device, by sliding contact with the counterpart member, the cleaning blade including:

a conductive support including a plate-shaped portion;

a blade part, that is formed on the plate-shaped portion, and is made of polyurethane rubber; and

a conductive adhesion layer that is provided between the plate-shaped portion and the blade part, and contains a conductive agent; wherein

the blade part contains a potassium salt in an amount of 0.3 mass % or more and less than 10 mass %, and

the potassium salt includes at least one kind of anion selected from the group consisting of CF₃SO₂C₄F₉SO₂N⁻, (CF₃SO₂)₂N⁻, (FSO₂)₂N⁻, C₂₈H₂₈BO₆⁻, AlCl₄⁻, Al₂Cl₇⁻, NO₃⁻, BF₄⁻, PF₆⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄F₉SO₂)₂N⁻, CF₂(CF₂SO₂)₂N⁻ and CF₃SO₂NH₂⁻.

In the cleaning blade, a potassium salt is contained in the blade part within the specific range as mentioned above, so that the potassium salt as an ion conductive agent can be inhibited from bleeding and/or blooming on the surface of the blade part. Accordingly, the cleaning blade hardly contaminates the counterpart member. In addition, the potassium salt tends not to impair the reactivity of a urethane catalyst unlike the ion conductive agents such as LiTFSI and LiFSI. For this reason, in the cleaning blade, even under the producing conditions as conventionally applied, the blade part, can be allowed to be cured, to surely obtain the adhesiveness to the plate shaped portion, and to fully bring out the rubber elasticity of the polyurethane rubber. Further, in the cleaning blade, because the blade part has high adhesion with the plate-shaped portion and the conductive adhesion layer, floating resulted front peeling in the boundary face between the blade part and the conductive adhesion layer hardly occurs during operation of the cleaning blade. Thus, in the cleaning blade, it is made possible to inhibit an increase of a contact electrical resistance between the blade part and the conductive adhesion layer. In this way, in the cleaning blade, a conductive path composed of the blade part, the conductive adhesion layer, and the conductive support can be surely established. Accordingly, when installed in the image forming device in a grounded state, the cleaning blade can scrape off and remove the toner utilizing the rubber elasticity of the polyurethane rubber in the blade part while destaticizing the residual toner.

Thus, according to the present disclosure, there can be provided a cleaning blade that hardly contaminates a counterpart member, hardly impairs the reactivity of a uretharic catalyst, and is able to scrape off a residual toner while destaticizing the residual toner.

### BRIEF DESCRIPTION OF DRAWINGS

FIG. 1 is a perspective view of a cleaning blade according to Embodiment 1.

FIG. 2 is a view schematically illustrating the section of the cleaning blade taken along II-II in FIG. 1.

FIG. 3 is a perspective view of a cleaning blade according to Embodiment 2.

FIG. 4 is a view schematically illustrating the section of the cleaning blade taken along IV-IV in FIG. 3.

### DETAILED DESCRIPTION

The aforementioned cleaning blade is used for removing a residual toner that remains on the surface of a counterpart member in an electrophotographic image forming device by sliding contact with the counterpart member. Specific examples of the image forming device may include image forming devices that employ an electrophotographic system using a charged image, such as copying machines, printers, facsimile machines, multifunction, machines and on-demanded printers. Examples of the counterpart member may include an image bearing member such as a photoreceptor drum, and an intermediate transfer belt. Herein, the intermediate transfer belt is used to transfer a toner image in the following way. The toner image carried on the image hearing member is primarily transferred onto the intermediate transfer belt, and then the toner image is secondarily transferred from the intermediate transfer belt onto a transfer material such as paper. More specifically, the cleaning blade can be used in the following way. That is, in the cleaning blade, the front edge portion of the blade part serves as a sliding contact portion for sliding contact with the counterpart member, and is made slidingly contact with the surface of the counterpart member under operation so as to scrape off and remove the residual toner that remains on the surface of the counterpart member and has been carried to the sliding contact portion.

The cleaning blade has a conductive support including a plate-shaped portion. The conductive support can be formed of a conductive material such as metal materials. Specifically, the plate-shaped portion can be formed, for instance, in a rectangular shape having a predetermined thickness. In such a configuration, the length of the plate-shaped portion in a longitudinal direction can be preferably set to 230 to 360 mm. The thickness of the plate-shaped portion can be preferably set to 1.2 to 2 mm. More specifically, the conductive support can be configured, for instance, to have an attaching portion that is connected to the plate-shaped, portion and is to be attached to a member of the image forming device. In such a configuration, the conductive support may be formed to have, for instance, an “L”-shaped cross section as a whole body.

The cleaning blade has a blade part that is formed on the plate-shaped portion and is made of polyurethane rubber. Specifically, the blade part can be formed on the side of a front end part of the plate-shaped portion in the transverse direction. The front end part of the plate-shaped portion may be buried in the blade part. Also on either one plate surface side of the plate-shaped, portion, the blade part may be bonded. In such a configuration, part of the blade part may be bonded to the front end face of the plate-shaped portion.

The blade part contains a potassium salt. That means that the blade part in the cleaning blade has been made conductive by the potassium salt. The potassium salt functions as an ion conductive agent. Thus, in the cleaning blade, the volume electric resistance of the blade part, is stabilized more easily in comparison with the case where an electron conductive agent such as a carbon black is added to the blade part. Further, in the cleaning blade, the blade part hardly suffers deterioration in compression set and permanent elongation, and increase in hardness.

In this regard, if the content of the potassium salt in the blade part is less than 0.3 mass %, addition of the potassium salt cannot have a conductivity imparting effect. For this reason, the content of the potassium salt in the blade part is set to 0.3 mass % or more. Herein, the content of the potassium salt is defined as a ratio (%) of the mass of the potassium salt contained in the blade part to the total mass of the blade part. In order to surely achieve effects of the added potassium salt, the content of the potassium salt in the blade part can be set preferably to 0.5 mass % or more, more preferably to 0.7 mass % or more, and further more preferably to 1 mass % or more. Meanwhile, if the content of the potassium salt in the blade part is 10 mass % or more, it is seen that the potassium salt tends to bleed and/or bloom, and increase of the consumption of the potassium salt raises the production cost. Thus, the content of the potassium salt in the blade part is set to 10% or less. From the viewpoint of balancing various factors such as the effects to be brought about by the added potassium salt, problems to be caused by bleeding/blooming of the potassium salt, and the production cost, the content of the potassium salt in the blade part can be set preferably to 9 mass % or less, more preferably 8 mass % or less, further more preferably 7 mass % or less, even further more preferably 6 mass % or less, and most preferably 5 mass % or less.

The anion in the potassium salt is, specifically at least one kind selected from the group consisting of CF₃SO₂C₄F₉SO₂N⁻ <nonafluoro-N-[(trifluoromethane) sulfonyl] butanesulfonylmide anion>, (CF₃SO₂)₂N⁻ <bis (trifluoromethanesulfonyl) imide anion>, (FSO₂)₂N⁻ <bis (fluorosulfonyl) imide anion>, C₂₈H₂₀BO₆⁻, AlCl₄⁻, Al₂Cl₇⁻, NO₃⁻, BF₄⁻, PF₆⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄F₉SO₂)₂N⁻, CF₂(CF₂SO₂)₂N⁻ and CF₃SO₂NH₂⁻. One kind or two or more kinds of the potassium salt may be contained in the blade part. In order to surely achieve the aforementioned operational effects, the anion in the potassium salt is preferably (CF₃SO₂)₂N⁻, CF₃SO₂C₄F₉SO₂N⁻, and/or C₂₈H₂₀BO₆⁻.

The cleaning blade includes a conductive adhesion layer that is provided between the plate-shaped portion and the blade part, and contains a conductive agent. The conductive adhesion layer has not only a role to bond the blade part that has been made conductive and the conductive support but also a role to connect the both electrically. When the front end part of the plate-shaped portion is buried in the blade part, the conductive adhesion layer can be provided between one plate surface of the plate-shaped portion and part of the blade part which oppose to the one plate surface, and between another plate surface of the plate-shaped portion and part of the blade part which oppose to the another plate surface. In such a configuration, the conductive adhesion layer can also be provided between the front end face of the plate-shaped portion and part of the blade part which opposes to the front end face. In addition, when the blade part is bonded on either one plate surface side of the plate-shaped portion, the conductive adhesion layer is provided between the either one plate surface and part of the blade part that opposes to the either one plate surface. In such a configuration, the conductive adhesion layer can also be provided between the front end face of the plate-shaped portion and part of the surface of the blade part.

Specifically, a conductive agent contained in the conductive adhesion layer may be either one of an electron conductive agent or an ion conductive agent. Specific examples of the electron conductive agent may include, for instance, a carbon black, a carbon nanotube, graphene, fine metal particles, metal oxide fine particles. These electron conductive agents can be used singly or in combination of two or more. As the ion conductive agent, quaternary ammonium salts, alkali metal salts and alkali earth metal salts can be exemplified. These ion conductive agents can be used singly or in combination of two or more. As the conductive agent, an electron conductive agent can be preferably used from the viewpoint of dispersibility to the conductive adhesion layer, and the like. As the electron conductive agent, specifically, a carbon black can be preferably used from the viewpoint of dispersibility to the conductive adhesion layer, controllability of dispersion, and the like.

Specifically, the conductive adhesion layer can contain a conductive agent preferably in an amount of 0.1 mass % or more, more preferably in an amount of 0.5 mass % or more, and furthermore preferably in an amount of 1 mass % or more from the viewpoint of, for instance, imparting conductivity. Meanwhile, specifically, the conductive adhesion layer can contain the conductive agent preferably in an amount of 10 mass % or less, more preferably in an amount of 8 mass % or less, and furthermore preferably in an amount of 5 mass % or less from the viewpoint of, for instance, adhesiveness and the like.

Specifically, the conductive adhesion layer can be composed of a resin adhesive containing a conductive agent. As the resin adhesive, a thermosetting resin adhesive or a thermoplastic resin adhesive can be used if these adhesive can bond the blade part made of polyurethane rubber and the conductive support. As the resin adhesive, a thermosetting resin adhesive is preferred from the viewpoint of adhesiveness and the like. As the thermosetting resin adhesive, an epoxy resin-based adhesive and an acrylic resin-based adhesive can be exemplified for instance.

The thickness of the conductive adhesion layer can be set preferably to 0.1 μm or more, more preferably to 0.3 μm or more, and furthermore preferably to 0.5 μm or more from the viewpoint of surely obtaining the adhesiveness. The thickness of the conductive adhesion layer can be set preferably to 20 μm or less, more preferably to 15 μm or less, and furthermore preferably to 10 μm or less from the viewpoint of processing stability.

In the cleaning blade, it is preferable that the conductive adhesion layer has a volume electric resistance that is equal to or is lower than that of the blade part. In such a configuration, if the thickness of the conductive adhesion layer that is thinner than the blade part is uneven, dispersion of the volume electric resistance in the conductive adhesion layer can be absorbed as dispersion of the volume electric resistance in the whole body of the cleaning blade. Consequently, the difference of the volume electric resistance per a cleaning blade can be easily reduced. The volume electric resistance of the conductive adhesion layer can preferably be lower than that of the blade part.

In the cleaning blade, from the viewpoint of advantageousness in scraping off the residual toner while destaticizing the residual toner, the volume electric resistance can be set preferably to 1×10¹⁰Ω or less, and more preferably to 9×10⁹Ω or less, and furthermore preferably to 8×10⁹Ω or less.

Herein, each configuration described above can be combined as needed in order to achieve the corresponding operational effects described above, and the like.

Hereinafter, the cleaning blades according to embodiments of the present disclosure will be described with reference to the drawings. It is noted that the same elements will be described using the same reference numbers.

### Embodiment 1

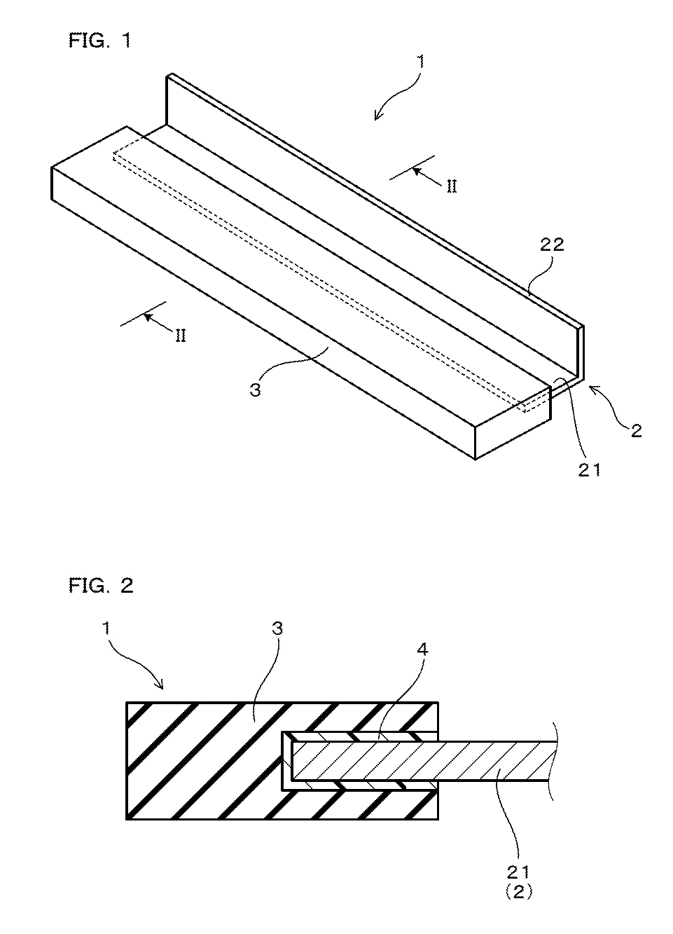

A cleaning blade according to Embodiment 1 will be described with reference to FIGS. 1 and 2. As illustrated in FIGS. 1 and 2, a cleaning blade 1 of the present embodiment is a cleaning blade for use to remove a residual toner (including not only a toner but also a toner external additive) remaining on the surface of a counterpart member in an electrophotographic image forming device by sliding contact with the counterpart member 1. In the present embodiment, the counterpart member is specifically a photoreceptor drum in an electrophotographic image tensing device.

The cleaning blade 1 has a conductive support 2 including a plate-shaped portion 21, a blade part 3 that is formed on the plate-shaped portion 21, and is made of polyurethane rubber, and a conductive adhesion layer 4 that is provided between the plate-shaped portion 21 and the blade part 3, and contains a conductive agent (not shown in figures). The blade part 3 contains a potassium salt (not shown in figures) in an amount of 0.3 mass % or more and less than 10 mass %.

In the present embodiment, the conductive support 2 has an attaching portion 22 that is integrally connected to the plate-shaped portion 21. The attaching portion 22 is a portion to be attached to a member of the image forming device. The conductive support 2 is formed to have an “L”-shaped cross section as a whole body. The blade part 3 is formed on the side of a front end part of the plate-shaped portion 21 in the transverse direction. The front end part of the plate-shaped portion 21 is buried in the blade part 3. The conductive adhesion layer 4 is provided between one plate surface of the plate-shaped portion 21 and part of the blade part 3 which oppose to the one plate surface, and between another plate surface of the plate-shaped portion 21 and part of the blade part 3 which oppose to the another plate surface, and also between the front end face of the plate-shaped portion 21 and part of the blade part 3 which opposes to the front end face.

### Embodiment 2

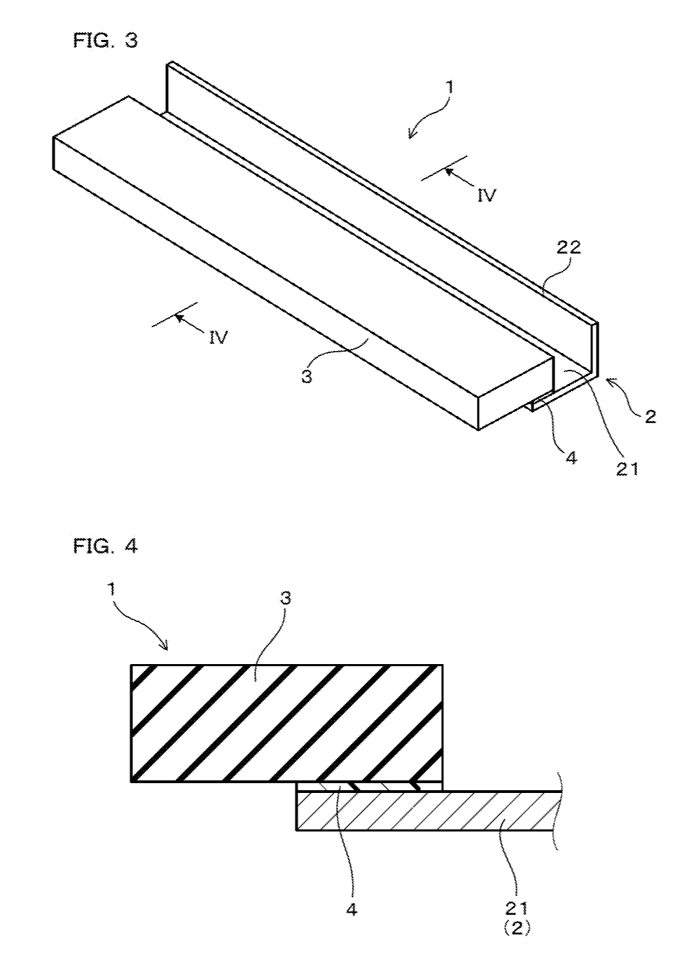

A cleaning blade according to Embodiment 2 will be described with reference to FIGS. 3 and 4. As illustrated in FIGS. 3 and 4, in the cleaning blade 1 of the present embodiment, the blade part 3 is bonded on one plate surface of the plate-shaped portion 21. The conductive adhesion layer 4 is provided between the one plate surface of the plate-shaped portion 21 and a part of the blade part 3 which opposes to the one plate surface. Other configurations are the same as those disclosed in Embodiment 1.

Hereinafter, the present disclosure will be described more specifically with reference to an experimental example.

### —Preparation of Urethane Rubber Compositions—

Forty four parts by mass of polybutylene adipate (PBA) (“Nippolan 4010” manufactured by Tosoh Corporation) subjected to defoaming in vacuum at 80° C. for 1 hour, and 56 parts by mass of 4,4-diphenylmethane diisocyanate (MDI) (“Millionate MT” manufactured by Tosoh Corporation) were mixed, and reacted under a nitrogen atmosphere at 80° C. for 3 hours to thereby prepare a main agent solution including a methane prepolymer. Herein, NCO % (mass %) in the main agent solution is 17.0%.

In addition, 87 parts by mass of polybutylene adipate (PBA) (“Nippolan 4010” manufactured by Tosoh Corporation), 13 parts by mass of a low molecular weight polyol obtained by mixing 1,4-butanediol (manufactured by Mitsubishi Chemical Corporation) and trimethyiolpropane (manufactured by Koei-Perstorp Co., Ltd.) in a weight ratio of 6:4, and 0.01 parts by mass of triethylenediamine (manufactured by Tosoh Corporation) serving as a catalyst were mixed under a nitrogen atmosphere at 80° C. for 1 hour to thereby prepare a curing agent solution having a hydroxy value (OHV) of 210 (KOHmg/g).

Subsequently, the main agent solution and the curing agent solution both prepared as described above, and an ion conductive agent were blended at a blending ratio of 94 parts by mass of the curing agent solution to 100 parts by mass of the main agent solution and at the ion conductive agent content shown in Table 1, and mixed under a vacuum atmosphere at 60° C. for 3 minutes to be sufficiently defoamed. In this way, urethane rubber compositions to be used in forming a blade part of each cleaning blade were prepared.

Herein, the followings were adopted for the ion conductive agents.
Cationic species: K⁺, Anionic species: CF₃SO₂C₄F₉SO₂N⁻ (“EF-N142” manufactured by Mitsubishi Materials Electronic Chemicals Co., Ltd.)
Cationic species: K⁺, Anionic species: (CF₃SO₂)₂N⁻ (“EF-N112” manufactured by Mitsubishi Materials Electronic Chemicals Co., Ltd.)
Cationic species: K⁺, Anionic species: C₂₈H₂₀BO₆⁻ (“LR-147” manufactured by Japan Carlit Co., Ltd.)
Cationic species: Li⁺, Anionic species: CF₃SO₂C₄F₉SO₂N⁻ (“EF-N145” manufactured by Mitsubishi Materials Electronic Chemicals Co., Ltd.)
Cationic species: Li⁺, Anionic species: (CF₃SO₂)₂N⁻ (“EF-N115” manufactured by Mitsubishi Materials Electronic Chemicals Co., Ltd.)
Cationic species: Na⁺, Anionic species: (CF₃SO₂) (“EF-N113” manufactured by Mitsubishi Materials Electronic Chemicals Co., Ltd.)
Cationic species: (C₄H₉)₄P⁺, Anionic species: Br⁻ (“IL-AP1B” manufactured by Koei chemical Co., Ltd.)

### —Curability in Urethane Rubber Compositions—

Each urethane rubber composition was coated so as to form a sheet-like coating having a thickness of 2 mm and was heated at 130° C. Where the urethane rubber composition had been cured in one minute, it was determined that the reactivity of the urethane catalyst was not impaired by the ion conductive agent and the curability of the urethane rubber composition under the conventional producing conditions was good. And this determination was ranked as “A”. Meanwhile, where the urethane rubber composition was not cured even after the lapse of five minutes., it was determined that the reactivity of the urethane catalyst was impaired by the ion conductive agent and the curability of the urethane rubber composition under the conventional producing conditions was defective. And this determination was ranked as “C”.

### Preparation of Adhesive—

A carbon black (“# 3030B” manufactured by Mitsubishi Chemical Corporation) as art electron conductive agent was added to an epoxy resin-based adhesive (“Aron Mighty AS-60” manufactured by Toagosei Co., Ltd.) so that the content of the conductive agent in the adhesion layer to lie formed would be the value shown in Table 1, and was thoroughly mixed spending 30 minutes. In this way, each adhesive for use in forming an adhesion layer of each cleaning belt was prepared. It is noted that the conductive agent was not added to some adhesives for comparison.

### —Preparation of Cleaning Blade Samples—

A molding die composed of an upper die and a lower die was prepared. The upper die and the lower die are brought closer to each other and clamped to thereby form a cavity having a size corresponding to two blade parts having an almost rectangular plate-like shape. This cavity is provided with two opposing receiving spaces. Each receiving space is structured so that the plate-shaped portion of the conductive support made of a metallic rectangular plate material (2 mm thickness) that has been bent to form an L-shaped cross section is placed.

Subsequently, a predetermined adhesive was applied to the front and rear plate surfaces and front end face of the front end part of the plate-shaped portion in the conductive support so as to reach a thickness of the adhesion layer as specified in Table 1 described later. Herein, the application width was set within the range of 2 mm as measured from the front end face to the base end side of the plate-shaped portion.

Subsequently, the conductive support on which the adhesive had been applied was placed in each receiving space of the molding die, and the molding die was clamped. Thereafter, a predetermined urethane rubber composition was injected into the cavity and heated at 130° C. for 5 minutes to be cured. Then, the resultant mold body was taken out from the molding die and was cut into two pieces so as to have a predetermined size. In this way, cleaning blade samples having a blade part (2 mm thickness) of polyurethane rubber and a conductive support which were integrated through an adhesion layer were prepared. Where the curability of the urethane rubber composition was ranked as “C”, the urethane rubber composition was heated for a prolonged time over five minutes until it was cured at 130° C., to thereby prepare a cleaning blade sample.

### [Resistance to Bleeding/Blooming]

Each cleaning blade had been left for two weeks in a moist heat environment of 40° C.×95% RH. Thereafter, bleeding and blooming of the ion conductive agent on the surface of the blade part were visually checked. Where neither bleeding nor blooming of the ion conductive agent was found on the surface of the blade part, the cleaning blade was determined to be excellent in resistance to bleeding and blooming and to have a very low possibility to contaminate the counterpart member, and was ranked as “A”. Where bleeding and blooming of the ion conductive agent was found on the surface of the blade part, the cleaning blade was determined to have a possibility to contaminate the counterpart member, and was ranked as “C”.

### —Destaticizing Property and Toner Scraping Performance—

The edge portion of the front end part of the blade part in the cleaning blade was brought into contact with a metal roller that is capable of applying a DC voltage of 100 V. A voltmeter was connected to the conductive support of the cleaning blade, and was grounded. Then, the volume electric resistance of the whole body of the cleaning blade at the time when 100 V was applied to the metal roller with the blade part of the cleaning blade being in contact with the metal roller was measured. Where the volume electric resistance was less than 1×10¹⁰Ω, the cleaning blade was determined to foe able to scrape off the residual toner while destaticizing the residual toner, and was ranked as “A”. Where the volume electric resistance was 1×10¹⁰Ω or more, the cleaning blade was determined not to be able to scrape off the residual toner while destaticizing the residual toner, and was ranked as “C”.

Table 1 shows a detailed specification of each cleaning blade and evaluation results thereof all together.

TABLE 1

| | Cationic | Anionic | | | | | | | | | | | | |
|---|---|---|---|---|---|---|---|---|---|---|---|---|---|---|
| | Species | Species | 1 | 2 | 3 | 4 | 5 | 1C | 2C | 3C | 4C | 5C | 6C | 7C |
| Kinds | K⁺ | CF₃SO₂C₄F₉SO₂N⁻ | ← | ← | ← | — | — | ← | ← | — | — | — | — | ← |
| of Ion | K⁺ | (CF₃SO₂)₂N⁻ | — | — | — | ← | — | — | — | — | — | — | — | — |
| Con- | K⁺ | C₂₈H₂₀BO₆⁻ | — | — | — | — | ← | — | — | — | — | — | — | — |
| ductive | Li⁺ | CF₃SO₂C₄F₉SO₂N⁻ | — | — | — | — | — | — | — | ← | — | — | — | — |
| Agents | Li⁺ | (CF₃SO₂)₂N⁻ | — | — | — | — | — | — | — | — | ← | — | — | — |
| | Na⁺ | CF₃SO₂)₂N⁻ | — | — | — | — | — | — | — | — | — | ← | — | — |
| | (C₄H₉)₄P⁺ | Br⁻ | — | — | — | — | — | — | — | — | — | — | ← | — |

| Blade Part | | | | | | | | | | | | | |
|---|---|---|---|---|---|---|---|---|---|---|---|---|---|
| | Content of Ion Conductive Agent | 0.3 | 2 | 5 | 2 | 2 | 0.1 | 10 | 2 | 2 | 2 | 2 | 2 |
| | (mass %) | | | | | | | | | | | | |
| Adhesion Layer | | | | | | | | | | | | | |
| | Conductivity | Yes | Yes | Yes | Yes | Yes | Yes | Yes | Yes | Yes | Yes | Yes | No |
| | | | | | | | | | | | | | (Insulative) |
| | Content of Conductive Agent | 2 | 2 | 2 | 2 | 2 | 2 | 2 | 2 | 2 | 2 | 2 | — |
| | (mass %) | | | | | | | | | | | | |
| | Thickness (μm) | 2.2 | 2.2 | 2.1 | 2.2 | 2.1 | 2.3 | 2.2 | 2.3 | 2.1 | 2.1 | 2.2 | 2.3 |
| Cleaning Blade as a whole body | | | | | | | | | | | | | |
| | Volume Electric Resistance | 6.3 × | 1.1 × | 9.2 × | 1.8 × | 2.8 × | 4.7 × | 7.7 × | 1.4 × | 2.2 × | 2.1 × | 3.6 × | 3.8 × |
| | (Ω · cm) | 10⁹ | 10⁹ | 10⁸ | 10⁹ | 10⁹ | 10¹⁰ | 10⁸ | 10⁹ | 10⁹ | 10⁹ | 10⁹ | 10¹⁰ |
| Eval- | Curability of | A | A | A | A | A | A | A | C | C | C | C | A |
| uation | Urethane Rubber Composition | | | | | | | | | | | | |
| | Resistance to Bleeding/Blooming | A | A | A | A | A | A | C | A | A | A | A | A |
| | Destaticizing Property and | A | A | A | A | A | C | A | A | A | A | A | C |
| | Toner Scraping Performance | | | | | | | | | | | | |

(*) “←” in the table shows the kind of the ion conductive agent listed in the left columns (which was used in the experimental example).

Table 1 makes certain the followings. In Sample 1C, the content of the potassium salt in the blade part is below the specified range. Therefore, Sample 1C cannot scrape off the residual toner while destaticizing the residual toner.

In Sample 2C, the content of the potassium salt in the blade part exceeds the specified range. Therefore, Sample 2C cannot inhibit bleeding and blooming of the ion conductive agent.

In Samples 3C through 6C, ion conductive agents other than a potassium salt were used. Therefore, in these samples, the reactivity of the urethane catalyst is impaired, and the curability of the urethane rubber composition was defective under the producing conditions as conventionally applied.

Sample 7C has no conductivity because the adhesion layer contains no conductive agent. Therefore, Sample 7C has a difficulty in scraping off the residual toner while destaticizing the residual toner.

It is concluded that in contrast with the aforementioned samples. Samples 1 through 5 enable to provide a cleaning blade that hardly contaminates a counterpart member, hardly impairs the reactivitiy of a urethane catalyst, and is able to scrape off a residual toner while destaticizing the residual toner.

The embodiments according to the present disclosure have been specified above, however, the present disclosure is not limited to these embodiments, and various modifications can be made within the scope that does not impair the purposes of the present disclosure.

1. A cleaning blade to be used for removing a residual toner that remains on a surface of a counterpart member in an electrophotographic image forming device, by sliding contact with the counterpart member, the cleaning blade comprising:
a conductive support including a plate-shaped portion;
a blade part that is formed on the plate-shaped portion, and is made of a polyurethane rubber; and
a conductive adhesion layer that is provided between the plate-shaped portion and the blade part, and contains a conductive agent; wherein
the blade part contains a potassium salt in an amount of 0.3 mass % or more and less than 10 mass %, and
the potassium salt includes at least one kind of anion selected from the group consisting of CF₃SO₂C₄F₉SO₂N⁻, (CF₃SO₂)₂N⁻, (FSO₂)₂N⁻, C₂₈H₂₀BO₆⁻, AlCl₄⁻, Al₂Cl₇⁻, NO₃⁻, BF₄⁻, PF₆⁻, CF₃COO⁻, CF₃SO₃⁻, (CF₃SO₂)₃C⁻, AsF₆⁻, SbF₆⁻, F(HF)N⁻, CF₃CF₂CF₂CF₂SO₃⁻, (CF₃CF₂SO₂)₂N⁻, CF₃CF₂CF₂COO⁻, (C₄F₉SO₂)₂N⁻, CF₂(CF₂SO₂)₂N⁻ and CF₃SO₂NH₂⁻.

2. The cleaning blade according to claim 1, wherein the anion in the potassium salt is at least one kind selected from the group consisting of CF₃SO₂C₄F₉SO₂N⁻, (CF₃SO₂)₂N⁻, and C₂₈H₂₀BO₆⁻.

3. The cleaning blade according to claim 2, wherein the conductive agent is an electron conductive agent.

4. The cleaning blade according to claim 3, wherein the electron conductive agent is a carbon black.

5. The cleaning blade according to claim 4, wherein a volume electric resistance thereof is 1×10¹⁰Ω or less.

6. The cleaning blade according to claim 5, wherein the conductive adhesion layer has a thickness of 0.1 μm or more and 20 μm or less.

7. The cleaning blade according to claim 6, wherein the conductive adhesion layer contains the conductive agent in an amount of 0.1 mass % or more and 10 mass % or less.

8. The cleaning blade according to claim 7, wherein the amount of the potassium salt is 1 mass % or more and less than 5 mass %.

9. The cleaning blade according to claim 8, wherein the volume electric resistance is 8×10⁹Ω or less.

10. The cleaning blade according to claim 9, wherein the thickness of the conductive adhesion layer is 0.5 μm or more and 10 μm or less.

11. The cleaning blade according to claim 10, wherein the anion in the potassium salt is CF₃SO₂C₄F₉SO₂N⁻.

12. The cleaning blade according to claim 1, wherein the anion in the potassium salt is CF₃SO₂C₄F₉SO₂N⁻.

13. The cleaning blade according to claim 1, wherein the conductive agent is an electron conductive agent.

14. The cleaning blade according to claim 13, wherein the electron conductive agent is a carbon black.

15. The cleaning blade according to claim 14, wherein a volume electric resistance thereof is 1×10¹⁰Ω or less.

16. The cleaning blade according to claim 15, wherein the conductive adhesion layer has a thickness of 0.1 μm or more and 20 μm or less.

17. The cleaning blade according to claim 16, wherein the conductive adhesion layer contains the conductive agent in an amount of 0.1 mass % or more and 10 mass % or less.

18. The cleaning blade according to claim 17, wherein the amount of the potassium salt is 1 mass % or more and less than 5 mass %.

19. The cleaning blade according to claim 18, wherein the volume electric resistance is 8×10⁹Ω or less.

20. The cleaning blade according to claim 19, wherein the thickness of the conductive adhesion layer is 0.5 μm or more and 10 μm or less.
